(19) United States
(12) Patent Application Publication
(10) Pub. No.: US 2026/0304043 A1
(43) Pub. Date: Oct. 1, 2026

(54) LOUDSPEAKERS AND METHODS OF USE THEREOF

(71) Applicant: Brane Audio, LLC, Austin, TX (US)

(72) Inventor: Joseph F. PINKERTON, Austin, TX (US)

(73) Assignee: BRANE AUDIO, LLC, Austin, TX (US)

(21) Appl. No.: 19/489,403

(22) PCT Filed: Jun. 3, 2024
(86) PCT No.: PCT/US2024/032250

§ 371 Date: Dec. 5, 2024

Related U.S. Application Data
(60) Provisional application No. 63/505,759, filed on Jun. 2, 2023.

(51) Int. Cl. H04R 11/02; H04R 3/08; H04R 11/14

(52) U.S. Cl. CPC H04R 11/02; H04R 3/08; H04R 11/14

(57) ABSTRACT

Electroacoustic drivers that can be utilized in loudspeaker systems that utilize drivers having a magnetic negative spring (MNS). The magnets of the MNS can be arranged such that a rotatable magnetic core is rotatable in the plane that is perpendicular to the axis of movement of the armature of the MNS, such that magnitude of the first magnetic negative spring force and magnitude of the second magnetic negative spring force of the MNS are varied based upon the position of rotation of the rotatable magnetic core. The loudspeaker can include an enclosure, a sound panel mechanically connected to the enclosure, and a magnetic negative spring having a first permanent magnet connected to an armature and a second permanent magnet that can rotate with respect to the first permanent magnet in response to a feedback signal.

### CROSS-REFERENCE TO RELATED PATENTS/PATENT APPLICATIONS

This application claims priority and benefit to U.S. Patent Appl. No. 63/505,759, filed on Jun. 2, 2023, to Joseph F. Pinkerton, entitled “Loudspeakers And Methods of Use Thereof,” and is commonly assigned to the Assignee of the present invention and is hereby incorporated herein by reference in its entirety for all purposes.

This application is also related to International Patent Application No. PCT/US2020/051633, filed Sep. 18, 2020, to Joseph F. Pinkerton et al., entitled “Electroacoustic Drivers And Loudspeakers Containing Same,” (the “Pinkerton '633 PCT Application”). The Pinkerton '633 PCT Application is incorporated herein in its entirety for all purposes.

This application is also related to International Patent Application No. PCT/US2022/041747, filed Aug. 26, 2022, to Joseph F. Pinkerton et al., entitled “Loudspeakers And Methods Of Use Thereof,” (the “Pinkerton '747 PCT Application”). The Pinkerton '747 PCT Application is incorporated herein in its entirety for all purposes.

This application is also related to U.S. patent application Ser. Nos. 18/319,079 and 18/319,113, each filed May 17, 2023, to Joseph F. Pinkerton et al., entitled “Loudspeakers And Methods Of Use Thereof.” U.S. patent application Ser. No. 18/319,113 (the “Pinkerton '113 Application”) is incorporated herein in its entirety for all purposes.

### TECHNICAL FIELD

The present invention relates to loudspeakers and methods of use thereof, and in particular loudspeakers having drivers including a magnetic negative spring (MNS) (such as repel-attract drivers (RAD)).

### BACKGROUND

FIG. 1 is a prior art audio force transducer 100 that includes a fixed magnetic flux path 101 (soft iron) having permanent magnets 102 and a sliding coil holder (also called an “armature”) 103 having electric coil (also called a “voice coil”) 104. The permanent magnets 102 are separated from the electric coil 104 with an air gap 105. The magnetic forces will cause the coil holder 103 to slide inward and outward in the z-axis direction (as shown in FIG. 1), which moves the panels of the loudspeakers (not shown) to produce the auditory sound.

As disclosed and taught in Pinkerton '633 PCT Application, large pressure forces on a sound panel (of an audio speaker) can be cancelled, or partially cancelled, by using a magnetic negative spring (MNS) as part of a repel-attract driver (RAD) (also known as a reluctance assist driver) or a permanent magnet crown (PMC) driver.

FIG. 2A (which is FIG. 18D of the Pinkerton '633 PCT Application) shows a perspective view showing certain parts (mainly the permanent magnets) of a repulsive/attractive MNS. FIG. 2B shows a perspective view of the armature that was utilized in the repulsive/attractive MNS shown in FIG. 2A.

As shown in FIGS. 2A-2B (which provides movement of the coil holder along the z-direction), one pole width of the voice coils 1815a-1815b are always immersed in the magnetic field (which makes the force per unit current input approximately constant at all armature positions).

The repulsive/attractive MNS shown in FIGS. 2A-2B has stationary magnetic poles (such as stationary magnetic north poles 1801a-1804a and stationary magnetic south poles 1801b-1804b), which are made with permanent magnets (in place of steel) and so the oppositely polarized moving magnets (such as moving magnetic north poles 1805a-1806a and moving magnetic south poles 1805b-1806b) on the armature are radially repelled by the stationary magnet poles (which provides radial stability). As shown in FIGS. 2A-2B, the stationary magnetic poles are permanent magnet rings (PMRs) and the moving magnetic poles are permanent magnetic triangles (PMTs). Alternatively, permanent magnet arc segments can be used in place of PMTs. The PMR could be an assemblage of arc segments that, when combined, create a ring magnet structure.

When the armature is in the centered position (as shown in FIG. 2C, which is FIG. 18A of the Pinkerton '633 PCT Application), the positive z-direction array of PMTs (moving magnetic north pole 1806a and moving magnetic south pole 1806b) is immersed in the oppositely directed magnetic field of the positive z-direction PMR (stationary magnetic north poles 1802a and 1804a and stationary magnetic south poles 1802b and 1804b) and thus is radially stable.

When the armature is in the partial negative z-direction position (as shown in FIG. 2D, which is FIG. 18B of the Pinkerton '633 PCT Application), this position the positive z-direction array of PMT (moving magnetic north pole 1806a and moving magnetic south pole 1806b) is partially immersed in the oppositely directed magnetic field of the positive z-direction PMR (stationary magnetic north poles 1802a and 1804a and stationary magnetic south poles 1802b and 1804b) and still radially stable. The axial/desired force in this position is high because the positive z-direction array of PMT (moving magnetic north pole 1806a and moving magnetic south pole 1806b) is being repelled by the positive z-direction PMR (stationary magnetic north poles 1802a and 1804a and stationary magnetic south poles 1802b and 1804b) and attracted by the magnetic fringing fields of negative z-direction PMR (stationary magnetic north poles 1801a and 1803a and stationary magnetic south poles 1801b and 1803b).

When the armature is in the full negative z-direction position (as shown in FIG. 2E, which is FIG. 18C of the Pinkerton '633 PCT Application), the positive z-direction array of PMT (moving magnetic north pole 1806a and moving magnetic south pole 1806b) is not immersed in the oppositely directed magnetic field of the positive z-direction PMR (stationary magnetic north poles 1802a and 1804a and stationary magnetic south poles 1802b and 1804b), but is partially immersed in the magnetic fringing field of the negative z-direction PMR (stationary magnetic north poles 1801a and 1803a and stationary magnetic south poles 1801b and 1803b), and this position still provides some radial stability. The axial/desired force in the position shown in FIG. 18C is also high because the positive z-direction array of PMTs is being repelled by the positive z-direction PMR magnetic fringing field and attracted by the negative z-direction PMR.

By symmetry, this same stability will be provided when the armature moves in the positive z-direction.

This provides a radial stabilizing force that helps to keep the armature centered within the air gap between the inner and outer permanent magnet rings.

FIG. 3 (which is FIG. 20 of the Pinkerton '633 PCT Application) shows a loudspeaker 2000 in which an MNS (such as shown in FIGS. 2A-2B) can be utilized. Loudspeaker 2000 has a sealed chamber (or sealed enclosure) 2001, a movable panel 2002 (which is connected to a flexible “surround” element 2005, such as made from rubber, to allow movable panel 2002 to move in the positive and negative z-direction). Loudspeaker 2000 further includes MNS 2003, and voice coil 2004, which are positioned for moving movable panel 2002 in the positive and negative z-direction. Loudspeaker 2000 further includes sensor 2006 (such as position and/or velocity sensor, that can be an optical or inductive sensor) used to provide position or velocity feedback to a control circuit). In the orientation of FIG. 3 (shown by the x-z axis shown therein, with the y-direction perpendicular thereto), movable sound panel 2002 moves outward and inward in the z-direction due to the z-direction movement of the armature. Such movement occurs due to the magnetic forces generated thereby.

When the sound panel is in its neutral/relaxed position, there are no forces acting on movable sound panel 2002. When movable sound panel 2002 moves in the positive z-direction, this creates a partial vacuum (i.e., a decrease in pressure) in sealed chamber 2001. When movable sound panel 2002 moves in the negative z-direction, this creates an increased pressure in sealed chamber 2001. Thus, there are additional forces that are created by this movement due to the decrease/increase in pressure.

### SUMMARY OF THE INVENTION

The present invention is directed to loudspeakers and methods of use thereof, and in particular loudspeakers having drivers including a magnetic negative spring (MNS) (such as repel-attract drivers (RAD) and permanent magnet crown (PMC) drivers).

In general, in one aspect, the invention features a loudspeaker. The loudspeaker includes an enclosure. The loudspeaker further includes a sound panel mechanically connected to the enclosure. The loudspeaker further includes a moveable armature mechanically connected to the sound panel including a voice coil. The moveable armature is operable for moving the sound panel toward the enclosure along a first axis to create a first air pressure force and away from the enclosure along the first axis to create a second air pressure force. The loudspeaker further includes a magnetic negative spring that has a first magnetic negative spring portion that is mechanically connected to the moveable armature and a second magnetic negative spring portion that is stationary along the first axis relative to the enclosure. The magnetic negative spring is operable to provide a first magnetic negative spring force when the sound panel is moving toward the enclosure along the first axis and a second magnetic negative spring force when the sound panel is moving away from the enclosure along the first axis. The first magnetic negative spring force is oppositely directed to the first air pressure force. The second magnetic negative spring force is oppositely directed to the second air pressure force. The first magnetic negative spring portion includes a first armature magnet. The second magnetic negative spring portion includes a rotatable magnetic core that is rotatable in the plane that is perpendicular to the first axis such that magnitude of the first magnetic negative spring force and magnitude of the second magnetic negative spring force are varied based upon position of rotation of the rotatable magnetic core.

Implementations of the invention can include one or more of the following features:

When the rotatable magnetic core is rotated to a first position, the magnitude of the first second magnetic negative spring force and magnitude of the second magnetic negative spring force can be maximized. When the rotatable magnetic core is rotated to a second position, the magnitude of the first second magnetic negative spring force and magnitude of the second magnetic negative spring force can be minimized. The rotatable magnetic core can be rotated to any position between the first position and the second position.

The minimized magnitude of the first second magnetic negative spring force and magnitude of the second magnetic negative spring force can be less than 20% of the maximum magnitude of the first second magnetic negative spring force and magnitude of the second magnetic negative spring force.

The minimized magnitude of the first second magnetic negative spring force and magnitude of the second magnetic negative spring force can be less than 10% of the maximum magnitude of the first second magnetic negative spring force and magnitude of the second magnetic negative spring force.

The maximum magnitude of the first second magnetic negative spring force and magnitude of the second magnetic negative spring force can be a peak force of over 50 Newtons.

The maximum magnitude of the first second magnetic negative spring force and magnitude of the second magnetic negative spring force can be a peak force of over 100 Newtons.

The maximum magnitude of the first second magnetic negative spring force and magnitude of the second magnetic negative spring force can be a peak force of over 200 Newtons.

The rotatable magnetic core can be operable to be rotated in response to a feedback sensor.

The feedback signal can be derived from a pressure sensor.

The feedback signal can be derived from a voice coil resonant frequency algorithm.

The feedback signal can be derived from a song file.

An algorithm can scan the song file to determine the primary low frequency note and instructs the rotatable magnetic core to rotate to a position that causes the voice coil resonant frequency to be near the frequency of the primary low frequency note.

The rotatable magnetic core can be rotated only when music is being played.

The loudspeaker can further include a position sensor that senses the position of the sound panel. The feedback signal can be derived from the position sensor.

The position sensor can be an infrared position sensor.

The rotatable magnetic core can be rotated by a rotating system including a motor.

The motor can be an electric motor.

The rotating system can further include a pulley and/or gear.

The rotatable magnetic core can include a closed magnetic circuit that includes a first ring magnet and a second ring magnet. The first ring magnet can include a plurality of first ring arc segment magnets that are positioned circumferentially in a plane that is perpendicular to the first axis and are separated circumferentially by first ring arc segment gaps. Each of the first ring arc segment magnets can include an inner first ring arc segment magnet and an outer first ring arc segment magnet. The inner first ring arc segment magnet can have a smaller radius than the outer first ring arc segment. The second ring magnet can include a plurality of second ring arc segment magnets that are positioned circumferentially in the plane that is perpendicular to the first axis and are separated circumferentially by second ring arc segment gaps. Each of the second ring arc segment magnets can include an inner second ring arc segment magnet and an outer first ring arc segment magnet. The inner second ring arc segment magnet can have a smaller radius than the outer second ring arc segment.

Each of the first ring arc segment magnets can have a same arc degree length as each of the second ring arc segment magnets.

Each of the first ring arc segment gaps can have a same arc degree length as each of the second ring arc segment gaps.

The ratio of the arc degree length of the first ring arc segment magnets and the arc degree length of the first ring arc segment gaps can be in the range between 1:1 and 2:1.

The arc degree length of each of the first ring arc segment magnets can be 60°.

The arc degree length of each of the first ring arc segment gaps can be 30°.

The arc degree length of each of the first ring arc segment magnets can 45°.

The arc degree length of each of the first ring arc segment gaps can be 45°.

The arc degree length of each of the first ring arc segment magnets can be x, wherein 45°≤x≤60°.

The arc degree length of each of the first ring arc segment gaps can be 90°−x.

The first ring magnet can include exactly four first ring arc segment magnets and four first ring arc segment gaps. The second ring magnet can include exactly four second ring arc segment magnets and four second ring arc segment gaps.

The voice coil and the magnetic negative spring can share the same magnetic circuit.

In general, in another aspect, the invention features a method. The method includes selecting any of the above-described loudspeakers. The method further includes rotating the rotatable magnetic core in the plane that is perpendicular to the first axis such that magnitude of the first second magnetic negative spring force and magnitude of the second magnetic negative spring force is changed. The method further includes operating the loudspeaker to produce auditory sound.

In general, in another aspect, the invention features a loudspeaker. The loudspeaker includes an enclosure. The loudspeaker further includes a sound panel mechanically connected to the enclosure. The loudspeaker further includes a magnetic negative spring having a first permanent magnet connected to an armature and a second permanent magnet that can rotate with respect to the first permanent magnet in response to a feedback signal.

Implementations of the invention can include one or more of the following features:

The first permanent magnet can include a first plurality of arc segments. The second permanent magnet can include a second plurality of arc segments.

The feedback signal can be a song file.

In general, in another aspect, the invention features a method. The method includes selecting any of the above-described loudspeakers. The method further includes rotating the second permanent magnet with respect to the first permanent magnet in response to the feedback signal. The method further includes operating the loudspeaker to produce auditory sound.

### DESCRIPTION OF DRAWINGS

FIG. 1 (which is FIG. 1 of the Pinkerton '633 PCT Application) is a schematic of a cross-sectional view of a prior art audio force transducer.

FIG. 2A (which is FIG. 18D of the Pinkerton '633 PCT Application) is an illustration of a perspective view showing certain parts (mainly the permanent magnets) of a prior art repulsive/attractive MNS (which is shown in FIGS. 2C-2E).

FIG. 2B is an illustration of a perspective view of the armature that was utilized in the prior art repulsive/attractive MNS shown in FIG. 2A.

FIGS. 2C-2E (which are, respectively, FIGS. 18A-18C of the Pinkerton '633 PCT Application) are schematics of a cross-sectional view of an embodiment of a prior art repulsive/attractive MNS with the voice coil armature in various positions (centered, partial negative z-direction, centered, and full negative z-direction, respectively).

FIG. 3 (which is FIG. 20 of the Pinkerton '633 PCT Application (with a change of orientation of the z-axis)) is a schematic of a loudspeaker in which an MNS (such as shown in FIG. 2A) can be utilized.

FIG. 4 is an illustration of a repulsive/attractive MNS in a max RAD force position.

FIGS. 5A-5B are illustrations (at different perspectives) of a repulsive/attractive MNS in a min RAD force position.

FIGS. 6A-6B is an illustration of an embodiment having a motor and pulley (or gear) that can rotate the magnetic core of the repulsive/attractive MNS.

FIG. 7 is a graph that shows power versus frequency for 6 mm voice coils, 28 AWG and 30 AWG.

FIGS. 8A-8B are illustration of another repulsive/attractive MNS in, respectively, a max RAD force position and a min RAD force position.

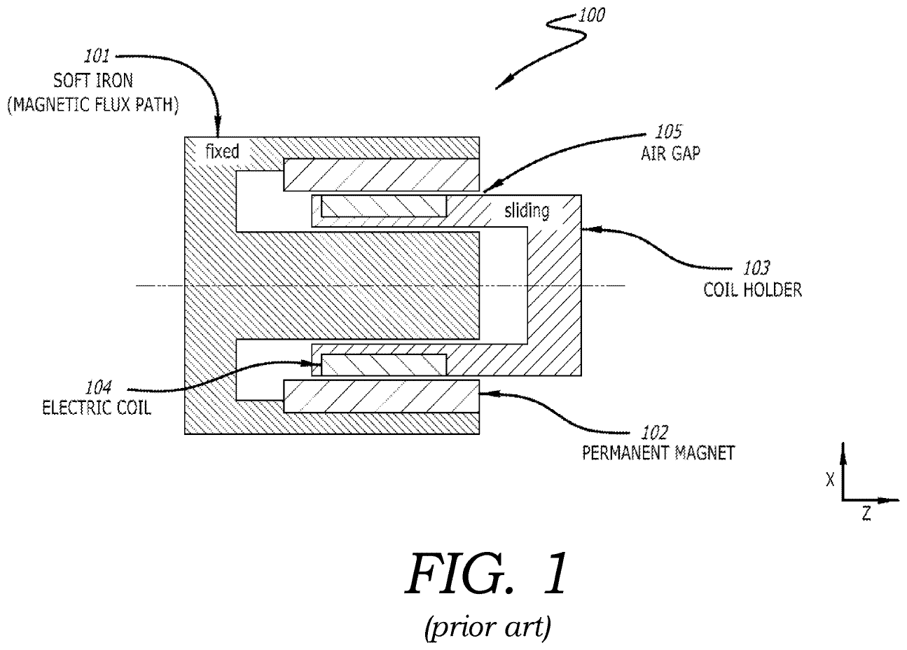

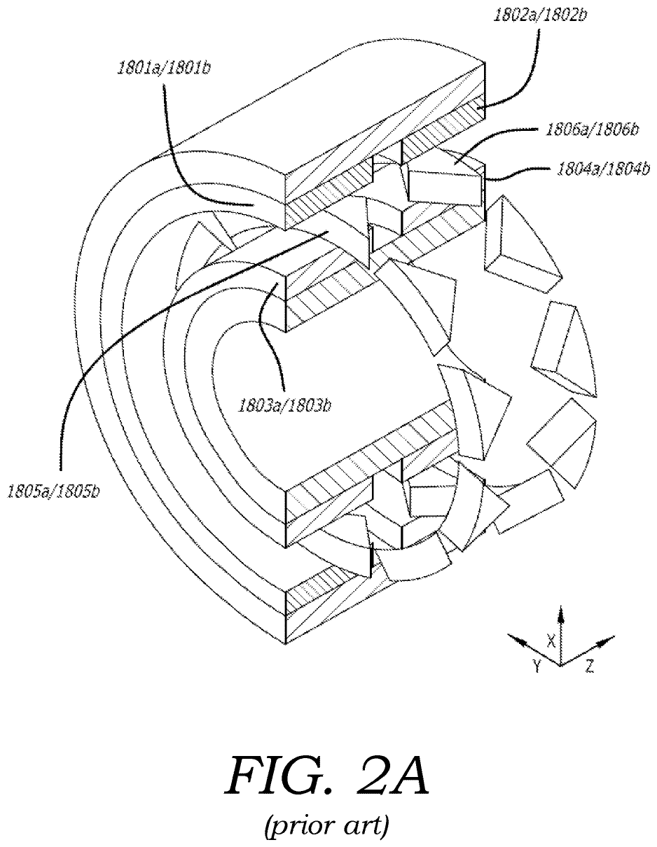

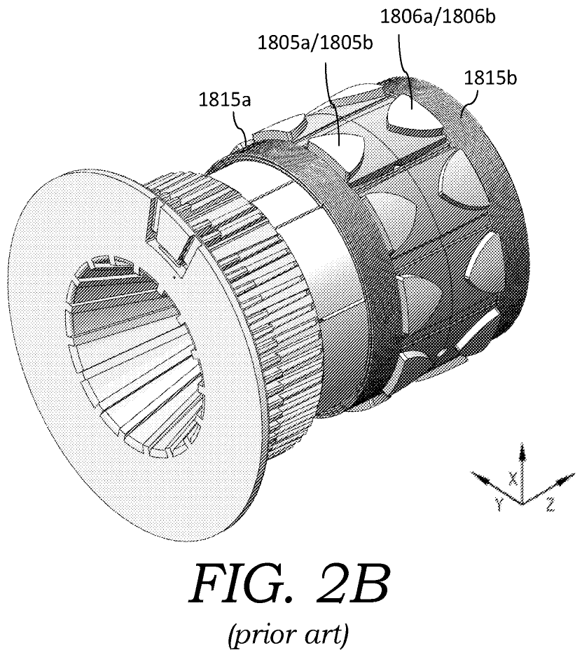

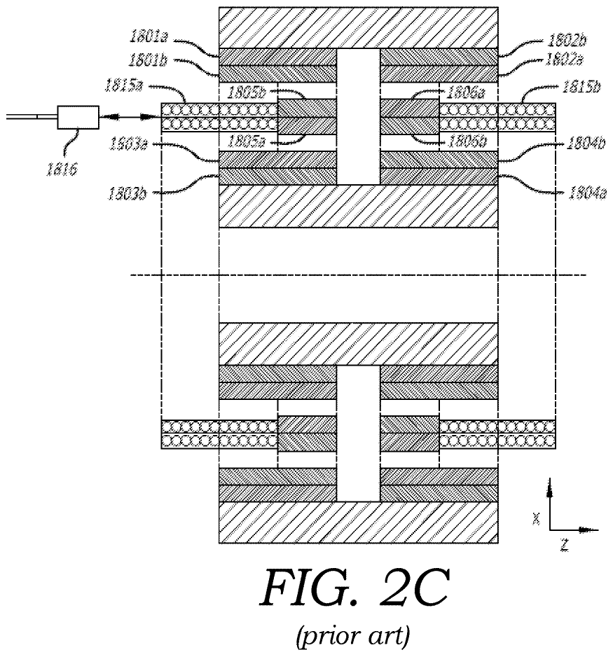

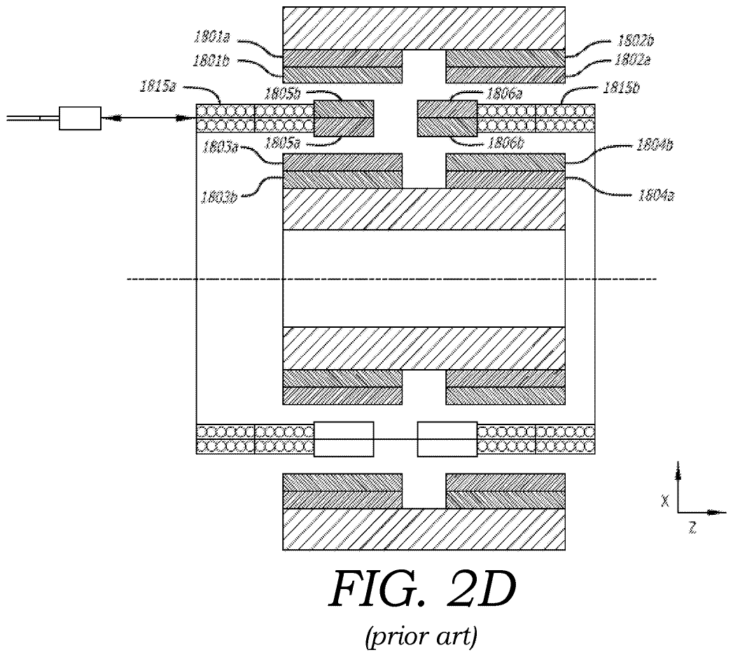

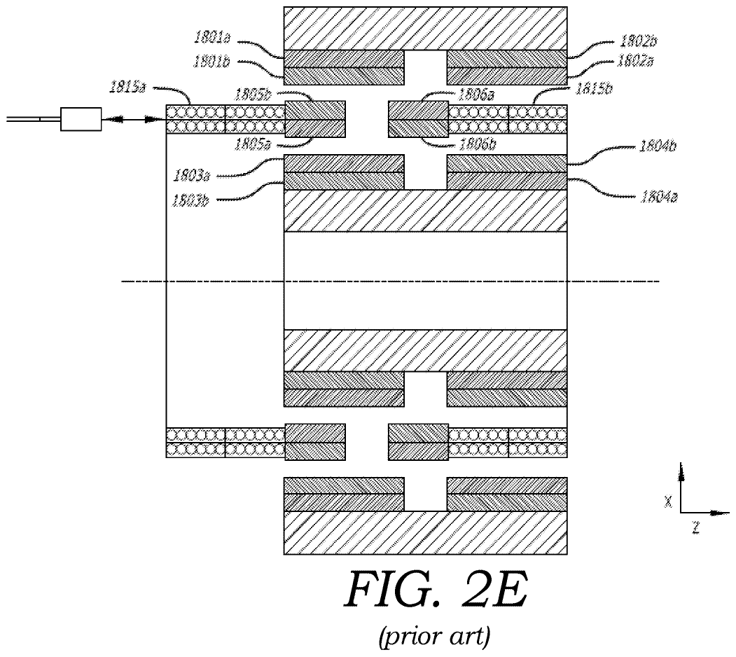

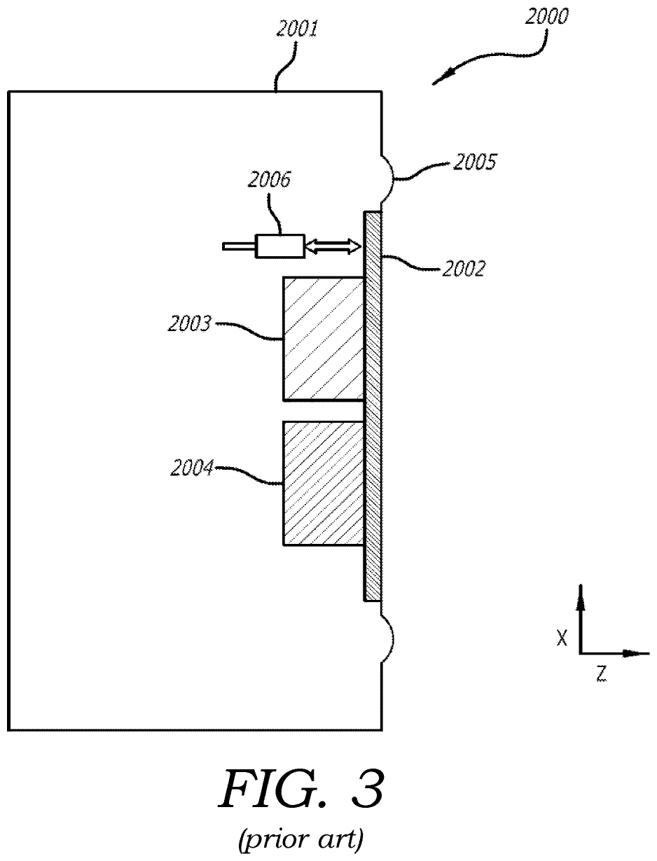

### DETAILED DESCRIPTION

The present invention is directed to loudspeakers and methods of use thereof, and in particular loudspeakers having drivers including a magnetic negative spring (MNS) (such as repel-attract drivers (RAD) and permanent magnet crown (PMC) drivers).

It has been discovered that the RAD force can be varied by more than five times (compared to about 1.1× for the moveable steel plunger mechanism described in the Pinkerton '113 Application) by rotating the magnetic core relative to the armature. Since the RAD force can essentially be turned off (to less than 20% of its max force) the launch mechanisms (such as the pump and valves) can be eliminated. I.e., the speaker can turn on instantly with the RAD force approximately off and then the RAD force can be increased as needed.

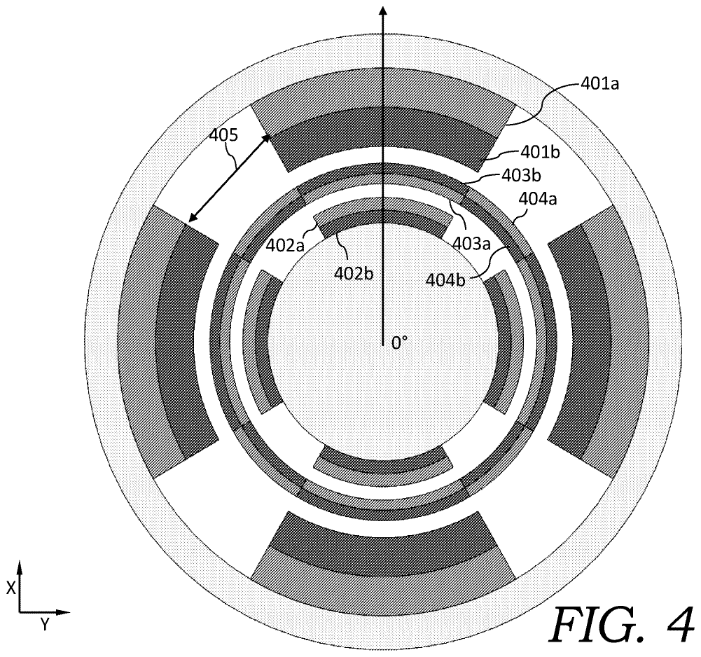

FIG. 4 shows an embodiment in the max RAD force position (rotation angle=0°). The outer stator magnets 401a-401b and the inner stator magnets 402a-402b take up 60° (instead of 90°) and there are 30° air spaces 405 between the 60° stator magnet arcs. As shown in FIG. 4, the outer stator magnets 401a-401b and the inner stator magnets 402a-402b that intersect the 0° line (running in the positive “x” direction) span from −30° to +30°.

Armature magnets 403a-403b that repel (outer stator magnets 401a-401b and the inner stator magnets 402a-402b) are completely immersed in the stator magnetic field and the armature magnets (such as armature magnets 404a-404b) that attract are outside of the stator field. In this max force position, the RAD behaves much like the RAD disclosed and taught in the Pinkerton '113 Application.

In the orientation of the FIG. 4, the view is in the x-y plane and perpendicular to the z-direction. The movement of the armature (and armature magnets 403a-403b and 404a-404b) of the RAD is in the z-direction.

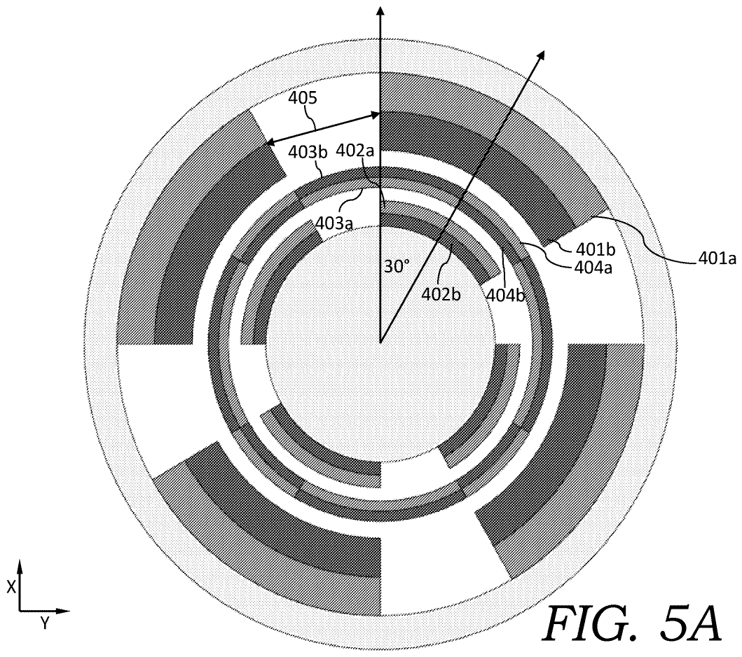

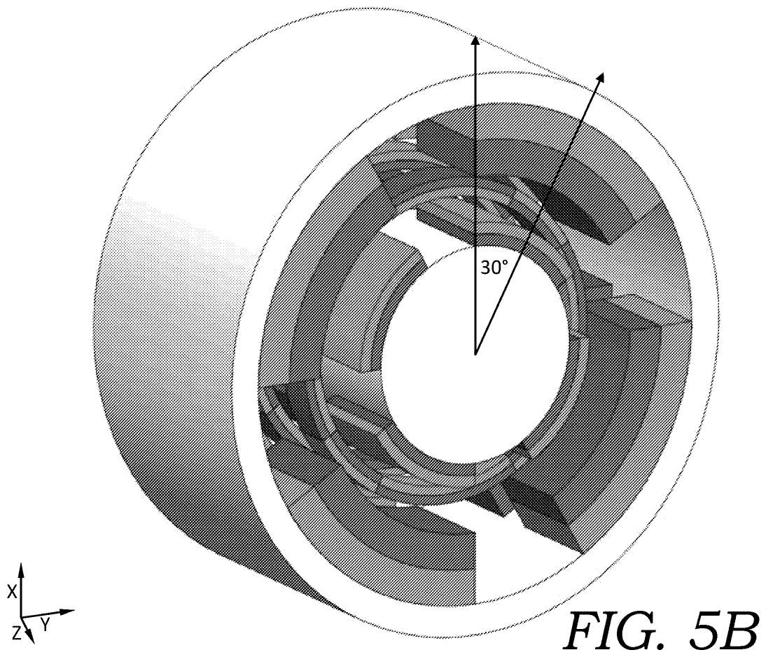

FIGS. 5A-5B shows the minimum RAD force position (rotation angle=30°). In this position, the armature magnets 403a-403b that repel are halfway out of the stator magnetic field and the armature magnets 404a-404b that attract are fully immersed in the stator field. Since the two types of armature magnets (repelling armature magnets 403a-403b and attracting armature magnets 404a-404b) produce oppositely directed axial forces (and each has the same immersion in the stator field) the RAD force is less than 20% of its max value. Similar to FIG. 4, in the orientation of the FIG. 5A, the view is in the x-y plane and perpendicular to the z-direction. FIG. 5B shows a perspective view of the angle RAD in its same minimum force position (rotation angle=30°) as shown in FIG. 5B.

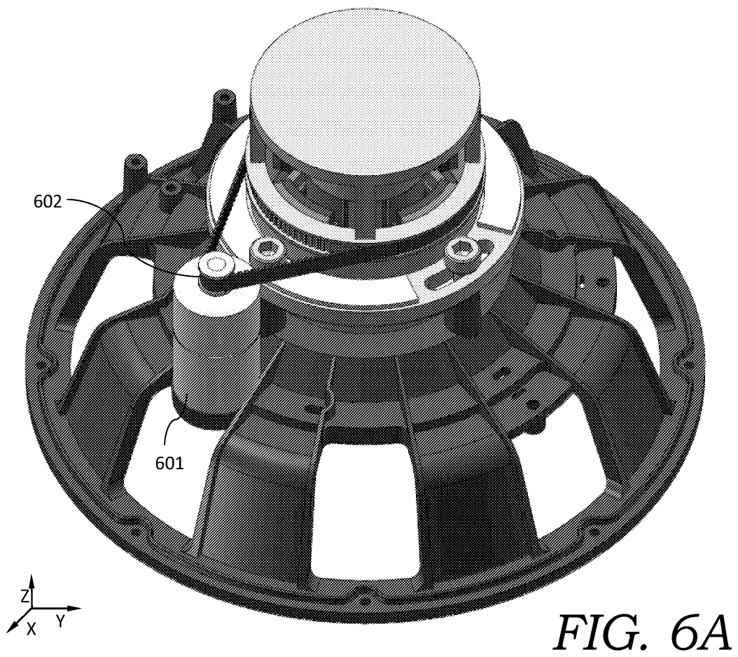

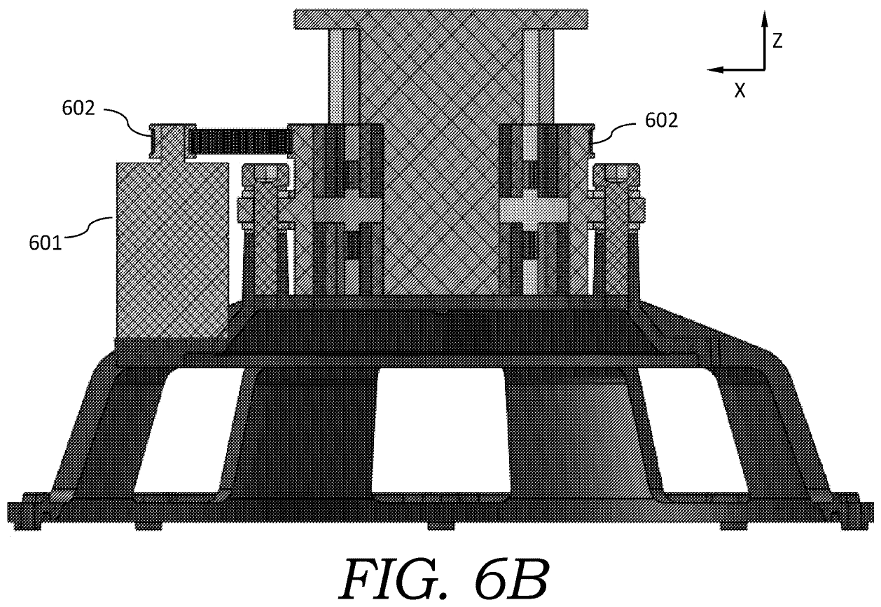

The RAD force position can be moved between the max RAD force position (rotation angle=0°) and the min RAD force position (rotation angle=30°). For example, a motor 601 and a pulley 602 (or gear), such as shown in FIG. 6A, can be used to rotate the magnetic core (with outer stator magnets 401a-401b and the inner stator magnets 402a-402b) in the x-y plane with respect to the armature (with repelling armature magnets 403a-403b and attracting armature magnets 404a-404b). A strong axial spring and axial bearing can be used to apply ~1000 Newtons of axial force to the core at all times (so that the core does not move axially when subjected to the ~+/−200 Newtons of RAD force).

As shown in FIGS. 4 and 5A-5B, outer stator magnets 401a-401b and the inner stator magnets 402a-402b have 60° stator magnet arcs. Thus the four sets of outer stator magnets and inner stator magnets take up a total of 240° of the 360° circumference, with four gaps 405 each having 30° arc length. This means, that for each gap 405 in FIGS. 4 and 5A-5B, 30° of stator magnet material has been removed between the 60° stator magnet arcs, which can be used to increase the radial thickness of the outer stator magnets 401a-401b (as shown in FIGS. 4 and 5A-5B). This allows the radial air gap between the inner and outer stator magnets to be increased or the magnetic field to be increased or both. This enables the max RAD force (since the armature magnets can be radially thicker with a larger radial air gap) to be roughly the same as a conventional RAD with no circumferential gap between stator magnets. The voice coil (on the armature) can also be thicker radially and thus have a lower electrical resistance to help make up for the fact that it has sections that are outside of the stator magnetic field (so its electrical efficiency can be roughly the same as a conventional RAD voice coil).

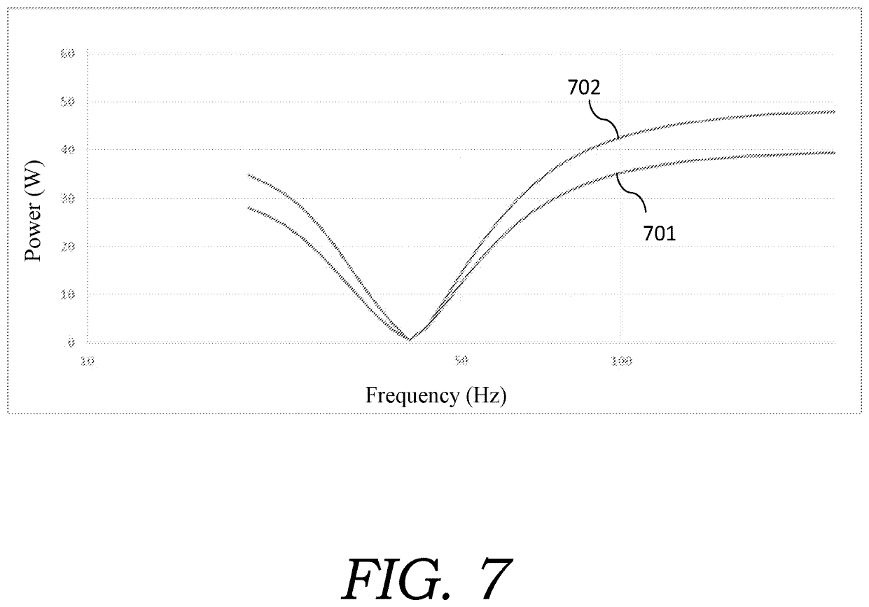

Rotating the magnetic core just a few degrees can compensate for large altitude (and thus atmospheric pressure) variations, manufacturing variances, and changes in spider-surround stiffness over time. Another significant advantage is a large increase in efficiency since the RAD resonant frequency can be rapidly adjusted over a 30-60 Hz range so that the frequency of the main deep note/notes of a given song can be matched with the RAD resonant frequency, resulting in an order of magnitude reduction in power draw, as shown in FIG. 7. FIG. 7 shows power versus frequency for 6 mm voice coils, 28 AWG and 30 AWG (plots 701-702, respectively).

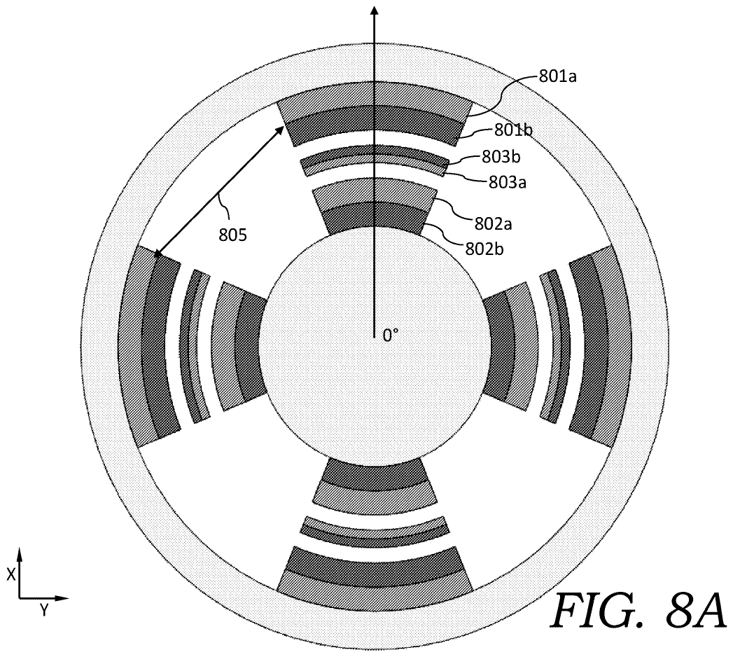

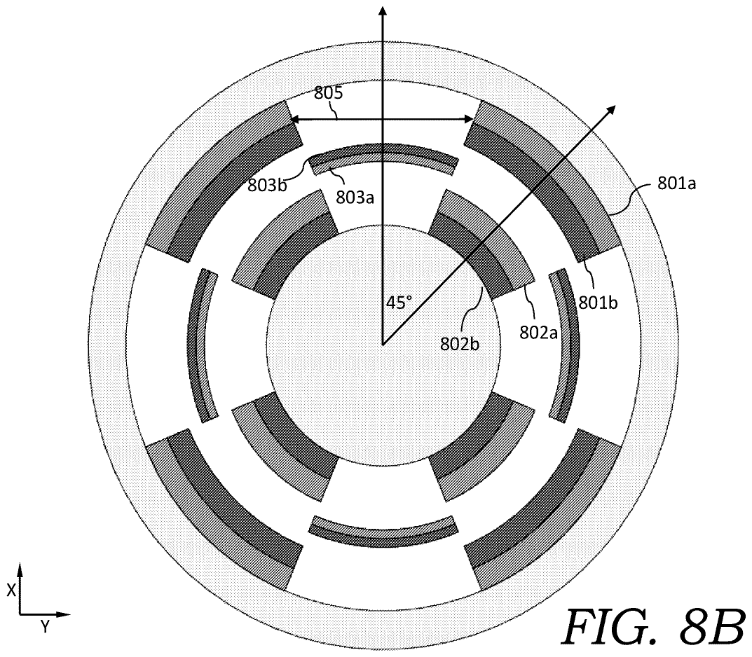

FIGS. 8A-8B show a different embodiment of the present invention that uses 45° stator magnet arcs and 45° of gaps 805 between stator magnets. I.e., outer stator magnets 801a-801b and the inner stator magnets 802a-802b have 45° stator magnet arcs (as opposed to the 60° stator magnet arcs shown in FIGS. 4 and 5A-5B). Gaps 805 are 45° (as opposed to 30° gaps shown in FIGS. 4 and 5A-5B). Similar to FIGS. 4 and 5A, in the orientation of FIGS. 8A-8B, the view is in the x-y plane and perpendicular to the z-direction. The movement of the armature (and armature magnets 803a-803b) of the RAD is in the z-direction.

FIG. 8A shows the MNS in the max RAD force position (rotation angle=0°), and FIG. 8B shows the MNS in the min RAD force position (rotation angle=45°). The max/min force ratio of this device is more than 10× (higher than the more than 5× ratio of the embodiment shown in FIGS. 4 and 5A-5B). However, the 45° rotation embodiment shown in FIGS. 8A-8B results in half of the voice coil being outside the stator magnetic field and so it needs twice the current to produce a given axial force. Even if the voice coil resistance can be cut in half (due to an increase in voice coil radial thickness), it will burn twice as much power for a given force relative to a conventional RAD voice coil.

Accordingly, the embodiment shown in FIGS. 4 and 5A-5B has an advantage in that 67% of the voice coil is immersed in the stator field so it needs just 1.5× more current for a given force (relative to a conventional RAD). If the voice coil has half the resistance (due to it being twice as thick radially) it will burn just 1.1× more power than a conventional RAD voice coil.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within +5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. A loudspeaker comprising:
(a) an enclosure;
(b) a sound panel mechanically connected to the enclosure;
(c) a moveable armature mechanically connected to the sound panel comprising a voice coil, wherein the moveable armature is operable for moving the sound panel toward the enclosure along a first axis to create a first air pressure force and away from the enclosure along the first axis to create a second air pressure force; and
(d) a magnetic negative spring that has a first magnetic negative spring portion that is mechanically connected to the moveable armature and a second magnetic negative spring portion that is stationary along the first axis relative to the enclosure, wherein
(i) the magnetic negative spring is operable to provide a first magnetic negative spring force when the sound panel is moving toward the enclosure along the first axis and a second magnetic negative spring force when the sound panel is moving away from the enclosure along the first axis,
(ii) the first magnetic negative spring force is oppositely directed to the first air pressure force,
(iii) the second magnetic negative spring force is oppositely directed to the second air pressure force,
(iv) the first magnetic negative spring portion comprises a first armature magnet, and
(v) the second magnetic negative spring portion comprises a rotatable magnetic core that is rotatable in the plane that is perpendicular to the first axis such that magnitude of the first magnetic negative spring force and magnitude of the second magnetic negative spring force are varied based upon position of rotation of the rotatable magnetic core.

2. The loudspeaker of claim 1, wherein
(a) when the rotatable magnetic core is rotated to a first position, the magnitude of the first magnetic negative spring force and magnitude of the second magnetic negative spring force are maximized,
(b) when the rotatable magnetic core is rotated to a second position, the magnitude of the first magnetic negative spring force and magnitude of the second magnetic negative spring force are minimized, and
(c) the rotatable magnetic core can be rotated to any position between the first position and the second position.

3. The loudspeaker of claim 2, wherein the minimized magnitude of the first magnetic negative spring force and magnitude of the second magnetic negative spring force is less than 20% of the maximum magnitude of the first magnetic negative spring force and magnitude of the second magnetic negative spring force.

4. The loudspeaker of claim 2, wherein the minimized magnitude of the first magnetic negative spring force and magnitude of the second magnetic negative spring force is less than 10% of the maximum magnitude of the first magnetic negative spring force and magnitude of the second magnetic negative spring force.

5. The loudspeaker of claim 2, wherein the maximum magnitude of the first magnetic negative spring force and magnitude of the second magnetic negative spring force is a peak force of over 50 Newtons.

6. The loudspeaker of claim 2, wherein the maximum magnitude of the first magnetic negative spring force and magnitude of the second magnetic negative spring force is a peak force of over 100 Newtons.

7. The loudspeaker of claim 2, wherein the maximum magnitude of the first magnetic negative spring force and magnitude of the second magnetic negative spring force is a peak force of over 200 Newtons.

8. The loudspeaker of claim 2, wherein the rotatable magnetic core is operable to be rotated in response to a feedback sensor.

9. The loudspeaker of claim 8, wherein the feedback signal is derived from a pressure sensor.

10. The loudspeaker of claim 8, wherein the feedback signal is derived from a voice coil resonant frequency algorithm.

11. The loudspeaker of claim 8, wherein the feedback signal is derived from a song file.

12. The loudspeaker of claim 11, wherein an algorithm scans the song file to determine the primary low frequency note and instructs the rotatable magnetic core to rotate to a position that causes the voice coil resonant frequency to be near the frequency of the primary low frequency note.

13. The loudspeaker of claim 11, wherein the rotatable magnetic core is rotated only when music is being played.

14. The loudspeaker of claim 8, wherein
(a) the loudspeaker further comprises a position sensor that senses the position of the sound panel; and
(b) the feedback signal is derived from the position sensor.

15. The loudspeaker of claim 14, wherein the position sensor is an infrared position sensor.

16. The loudspeaker of claim 1, wherein the rotatable magnetic core is rotated by a rotating system comprising a motor.

17. The loudspeaker of claim 16, wherein the motor is an electric motor.

18. The loudspeaker of claim 16, wherein the rotating system further comprises a pulley and/or gear.

19. The loudspeaker of claim 1, wherein
(a) the rotatable magnetic core comprises a closed magnetic circuit that comprises a first ring magnet and a second ring magnet,
(b) the first ring magnet comprises a plurality of first ring arc segment magnets that are positioned circumferentially in a plane that is perpendicular to the first axis and are separated circumferentially by first ring arc segment gaps,
(c) each of the first ring arc segment magnets comprises an inner first ring arc segment magnet and an outer first ring arc segment magnet, wherein the inner first ring arc segment magnet has a smaller radius than the outer first ring arc segment,
(d) the second ring magnet comprises a plurality of second ring arc segment magnets that are positioned circumferentially in the plane that is perpendicular to the first axis and are separated circumferentially by second ring arc segment gaps, and
(e) each of the second ring arc segment magnets comprises an inner second ring arc segment magnet and an outer first ring arc segment magnet, wherein the inner second ring arc segment magnet has a smaller radius than the outer second ring arc segment.

20. The loudspeaker of claim 19, wherein each of the first ring arc segment magnets has a same arc degree length as each of the second ring arc segment magnets.

21. The loudspeaker of claim 20, wherein each of the first ring arc segment gaps has a same arc degree length as each of the second ring arc segment gaps.

22. The loudspeaker of claim 21, wherein the ratio of the arc degree length of the first ring arc segment magnets and the arc degree length of the first ring arc segment gaps is in the range between 1:1 and 2:1.

23. The loudspeaker of claim 21, wherein the arc degree length of each of the first ring arc segment magnets is 60°.

24. The loudspeaker of claim 23, wherein the arc degree length of each of the first ring arc segment gaps is 30°.

25. The loudspeaker of claim 21, wherein the arc degree length of each of the first ring arc segment magnets is 45°.

26. The loudspeaker of claim 25, wherein the arc degree length of each of the first ring arc segment gaps is 45°.

27. The loudspeaker of claim 21, wherein the arc degree length of each of the first ring arc segment magnets is x, wherein 45°≤x≤60°.

28. The loudspeaker of claim 27, wherein the arc degree length of each of the first ring arc segment gaps is 90°−x.

29. The loudspeaker of claim 19, wherein
(a) the first ring magnet comprises exactly four first ring arc segment magnets and four first ring arc segment gaps; and
(b) the second ring magnet comprises exactly four second ring arc segment magnets and four second ring arc segment gaps.

30. The loudspeaker of claim 1, wherein the voice coil and the magnetic negative spring share the same magnetic circuit.

31. A method comprising:
(a) selecting a loudspeaker
(i) an enclosure,
(ii) a sound panel mechanically connected to the enclosure,
(iii) a moveable armature mechanically connected to the sound panel comprising a voice coil, wherein the moveable armature is operable for moving the sound panel toward the enclosure along a first axis to create a first air pressure force and away from the enclosure along the first axis to create a second air pressure force, and
(iv) a magnetic negative spring that has a first magnetic negative spring portion that is mechanically connected to the moveable armature and a second magnetic negative spring portion that is stationary along the first axis relative to the enclosure, wherein
(A) the magnetic negative spring is operable to provide a first magnetic negative spring force when the sound panel is moving toward the enclosure along the first axis and a second magnetic negative spring force when the sound panel is moving away from the enclosure along the first axis,
(B) the first magnetic negative spring force is oppositely directed to the first air pressure force,
(C) the second magnetic negative spring force is oppositely directed to the second air pressure force,
(D) the first magnetic negative spring portion comprises a first armature magnet, and
(E) the second magnetic negative spring portion comprises a rotatable magnetic core that is rotatable in the plane that is perpendicular to the first axis such that magnitude of the first magnetic negative spring force and magnitude of the second magnetic negative spring force are varied based upon position of rotation of the rotatable magnetic core;
(b) rotating the rotatable magnetic core in the plane that is perpendicular to the first axis such that magnitude of the first magnetic negative spring force and magnitude of the second magnetic negative spring force is changed; and
(c) operating the loudspeaker to produce auditory sound.

32-35. (canceled)
